(19) United States
(12) Patent Application Publication
(10) Pub. No.: US 2024/0314030 A1
(43) Pub. Date: Sep. 19, 2024

(54) MANAGEMENT OF AT LEAST ONE ORCHESTRATION ENTITY IN A COMPUTER NETWORK

(71) Applicants: ORANGE, ISSY-LES-MOULINEAUX (FR); CONSERVATOIRE NATIONAL DES ARTS ET METIERS, PARIS CEDEX 03 (FR)

(72) Inventors: Jose Manuel Sanchez Vilchez, CHATILLON CEDEX (FR); Alessio Diamanti, CHATILLON CEDEX (FR); Stefano Secci, PARIS (FR)

(21) Appl. No.: 18/576,525

(22) PCT Filed: Jul. 4, 2022
(86) PCT No.: PCT/FR2022/051332

§ 371 Date: Jan. 4, 2024

(30) Foreign Application Priority Data
Jul. 5, 2021 (FR) FR2107239

(51) Int. Cl. H04L 41/0816

(52) U.S. Cl. CPC H04L 41/0816

(57) ABSTRACT

A method for managing at least one orchestration entity in a computer network is described. The method includes obtaining an indication regarding whether the orchestration entity has performed at least one orchestration action in the network during a time window, obtaining at least one state of the network in the time window, the network state including a state of a service implemented in the network and a state of at least one operational layer of the network used to implement the service, obtaining, on the basis of the network state and of a reference state of the network, a reputation value representative of an improvement or a degradation in a network state, and sending the reputation value to the orchestration entity.

### PRIOR ART

The invention relates to the general field of telecommunications. It is more specifically in the context of networks known as “software networks”, based on SDN (Software Defined Networking) and NFV (Network Functions Virtualization) technologies.

The invention finds a particular but non-limiting application in fifth generation (5G) networks which rely on these SDN and NFV technologies to offer specialized/vertical service providers (telemedicine, security, autonomous vehicle, virtual private network or VPN, videoconference, etc.), through “network slices”, services in which the level of performance (in terms of latency, flow rate, reliability, etc.) is certified by a Service Level Agreement (SLA) established between the operator and the service provider.

FIG. 1 schematically represents the architecture of a software network of the state of the art, only the main components useful for the understanding of the invention, all known to those skilled in the art, being represented.

In FIG. 1, the upper layer FOP combines the operator's business and support functions. A service which relies on virtualized network functions VNF is considered. This service is implemented using two operational layers, namely a layer LM of hardware and software resources and a layer LV of virtualized resources. These operational layers LM, LV can be deployed on a network function virtualization infrastructure NFVI, typically located in one or several data centers interconnected together. This NFVI infrastructure offers, via a virtualization layer VL, access to all the hardware and software resources of the layer LM which constitute the environment in which the VNFs are deployed.

This FIG. 1 represents CPU type resources C, memory type resources M, disk type resources D and network type resources N in the layer LM of the hardware and software resources. Corresponding virtualized resources are referenced in the same way in the layer LV of the virtual resources.

The deployment, execution and operation of VNFs in the NFVI infrastructure are driven by management and orchestration (MANO) functions comprising:
an NFV orchestrator (NFVO) in charge of the life cycle of the network services;
a manager (VNFM) in charge of the life cycle of the VNFs; and
a manager (VIM) in charge of the management of the resources of the NFVI infrastructure. The VIM manager is particularly responsible for the placement of the virtual machines and the management of their life cycles.

Moreover, and in a known manner, the SDN dissociates the control plane of the network from the data routing plane. The control plane is implemented in SDN controllers. This FIG. 1 represents two SDN controllers, more specifically a T-SDN controller (Tenant SDN controller) and an I-SDN controller (Infrastructure SDN controller), following the ETSI NFV standard defined in document ETSI GS NFV-EVE 005, “Network Functions Virtualization (NFV); Ecosystem; Report on SDN Usage in NFV Architectural Framework,” v. 1.1.1, December 2015.

The T-SDN and I-SDN controllers are particularly responsible for choosing the packet routing path, respectively at the level of the virtual resource layer and at the level of the hardware and software resource layer.

In this document, “orchestration entities” EO refers to the MANO management and orchestration functions NFVO, VNFM, VIM and the SDN controllers T-SDN, I-SDN. These orchestration entities EO act on a group of resources in an operational layer LM, LV. For example:
the VIM manager can change the quantity of CPU allocated to a virtual machine by acting on the CPU type resources C of the layer LV of the virtual resources;
the T-SDN controller acts on the network type resources N of the layer LV of the virtual resources;
the I-SDN controller acts on the network type resources N of the layer LM of the hardware and software resources.

Software networks allow to meet the levels required in particular by the 5G networks because the network delivery and management become highly dynamic (with services composed of virtualized resources, deployed on the fly). However, software networks introduce new potential weaknesses, in particular due to the distribution of decision-making. For example, the SDN controllers can make control decisions, and other orchestration entities, such as the VNFM manager or the NFVO orchestrator can decide to reconfigure functions of the software network.

The management of the SDN/NFV networks can reach a level of functional complexity that is difficult to master. This level of complexity is mainly due to two factors:
the separation between software and hardware through the hypervisor constituting the virtualization software platform of the NFV system; and
the separation between the data transfer or routing plane (data plane) and the control plane in SDN architectures (for access to the controller) and as well as for the NFV architectures (for the access to the orchestrator).

These two factors lead to a multi-layered SDN/NFV architecture, in which different management entities (such as orchestrators) and different control entities (such as SDN controllers) can make critical decisions that are difficult to anticipate or control and that may impact the quality of service QoS.

The invention aims at a solution for improving the control of the software networks.

### DISCLOSURE OF THE INVENTION

More specifically, and according to a first aspect, the invention relates to a method for managing at least one orchestration entity in a software network, this method including:
a step of obtaining an indication that said orchestration entity has performed at least one orchestration action in said network during a time window;
a step of obtaining at least one state of the network in said time window, said state of the network including a state of a service implemented in the network and a state of at least one operational layer of the network for the implementation of said service;
a step of obtaining, from said state of the network and a reference state of the network, a reputation value representative of an improvement or deterioration of a state of the network; and
a step of sending said reputation value to said orchestration entity.

In this document; “operational layers” refers to:
the layer of the hardware and software resources used for the implementation of the service; and
the layer of the virtualized resources used for the implementation of the service.

Correlatively, the invention relates to a device for managing at least one orchestration entity in a software network, this device including:
a module for obtaining an indication that said orchestration entity has performed at least one orchestration action in said network during a time window;
a module for obtaining at least one state of the network in said time window, said state of the network including a state of a service implemented in the network and a state of at least one operational layer of the network for the implementation of said service;
a module for obtaining, from said state of the network and a reference state of said network, a reputation value representative of an improvement or deterioration of a state of the network; and
a module for sending said reputation value to said orchestration entity.

According to a second aspect, the invention relates to an orchestration method implemented by an orchestration entity in a software network, the method including:
a step of sending, to a management device, an indication that said orchestration entity has performed at least one orchestration action in said network during a time window;
a step of receiving a reputation value obtained by said management device by implementing a method as mentioned above; and
a step of taking into account said reputation value to select an orchestration action to be performed in said network.

Correlatively, the invention relates to an orchestration entity including:
a module for sending, to a management device as mentioned above, an indication that said orchestration entity has performed at least one orchestration action in said network during a time window;
a module for receiving a reputation value coming from said management device; and
a module for selecting an orchestration action, configured to take into account said reputation value to select an orchestration action to be performed in said network.

Thus, and in general, the invention proposes a management method and device configured to determine whether an orchestration action performed by an orchestration entity in a software network has the effect of improving or degrading the state of the network. This management device calculates a value called reputation value representative of this improvement or this degradation and communicates it to the orchestration entity.

The orchestration entity uses this reputation value to select the future orchestration actions it performs in the software network. These reputation values thus serve as feedback to the orchestration entities on the impact of their orchestration actions on the state of the network and allow them to adapt these orchestration actions accordingly.

Examples of orchestration actions are given in document “ETSI GS NFV-IFA 010 V2.2.1 (2016-09), Network Functions Virtualization (NFV), Management and Orchestration, Functional requirements specification”. As examples:
the NFVO orchestrator coordinates the assignment of the hardware resources, for example by reserving or releasing physical hardware resources from the data center. The NFVO orchestrator can for example take an orchestration action to choose not to use or release a failed or overloaded VNF;
the VNFM manager creates, maintains and releases the instances of the virtual functions VNF: creation, scaling, maintenance and release of the instances of the VNF. The VNFM manager can for example take an orchestration action to add an instance of a VNF;
the VIM manager manages the allocation, addition, release and recovery of the resources of the NFVI infrastructure (storage, CPU, network cards, memories, etc.) as well as their optimization. The VIM manager can for example take an orchestration action to allocate computing resources to the virtual machines;
an SDN controller can for example take an orchestration action to configure a new network path for routing the packets when it detects that a path in use is failed or congested.

It is customary in this context to define by “resilience” the capacity of an orchestration entity or of a system to respond to and compensate for deviations in the state of the network by applying orchestration actions to return from a state of the network degraded by a disturbance to a known and stable reference state.

Particularly remarkably, the invention proposes a solution for improving the resilience of the orchestration entities by setting up a reputation mechanism that evaluates the impact of the orchestration actions executed by these entities in terms of deviation on the resilience of the network.

The management device is typically implemented in a central function of the software network to manage all the orchestration entities, such as in particular the SDN controllers and the MANO management and orchestration functions (NFVO, VNFM, VIM) mentioned previously.

As mentioned previously, the state of the network can be defined by a state of the service and by a state of at least one operational layer allowing the implementation of this service.

The state of the service can be obtained from metrics describing the service at different instants of the time window. As an example:
a latency metric;
a jitter metric;
a bandwidth metric;
a number of failed calls, etc.
   can be used.

With regard to the state of the operational layer(s), (i) a state of a layer of hardware and software resources and/or (ii) a state of a layer of virtual resources of said network can for example be used.

The state of an operational layer in a time window is for example obtained from metrics describing this layer at different instants of this time window.

As an example, operational metrics used to describe a layer of hardware and software resources at a given instant can comprise:
metrics relating to the occupancy or statuses of CPUS;
metrics relating to the occupancy or statuses of memories;
metrics relating to the occupancy or statuses of disks; and
metrics relating to the occupancy or statuses of network resources.

Likewise, still by way of example, operational metrics used to describe a layer of virtual resources at a given instant can comprise:
metrics relating to the occupancy or statuses of virtualized CPU functions;
metrics relating to the occupancy or statuses of virtualized memory functions;
metrics relating to the occupancy or statuses of virtualized disk functions; and
metrics relating to the occupancy or statuses of virtualized network functions.

In one embodiment of the invention, the state of the network is computed by a learning-based system taking as input the service metrics and at least a subset of the metrics of at least one operational layer.

In one embodiment of the invention, the operational layer (layer of the hardware and software resources or layer of the virtual resources) is described based on the metrics of a single group of resources.

For example, these could be CPU type metrics, memory type metrics, disk type metrics or network resource type metrics.

In practice, this embodiment is advantageous because an orchestration action generally targets a single group of resources, for example adding the memory, performing vertical or horizontal CPU scaling.

In one particular embodiment of the invention, the reputation value is increased or decreased depending on whether the state of the network approaches or deviates from the reference state compared to a state in which the network was in a time window prior to said time window.

In one particular embodiment, to calculate a distance between two states of the network, these states are represented in a two-dimensional space in which a first dimension represents the state of the service and a second dimension represents the state of the operational layer which makes this service in the network.

Such a space, known as “resilience space” was defined by Sterbenz et. al in document “Evaluation of network resilience, survivability, and disruption tolerance: analysis, topology generation, simulation, and experimentation 2013-02.”.

The invention also relates to a system including a management device and at least one orchestration entity as mentioned above.

The management and orchestration methods can be implemented by a computer program.

Consequently, the invention also aims a computer program on a recording medium, this program being capable of being implemented in a computer, this program includes instructions allowing the implementation of a management method or the implementation of an orchestration method as described above.

This program can use any programming language, and be in the form of source code, object code or intermediate code between source code and object code, such as in a partially compiled form or in any other desirable form.

The invention also relates to an information medium or a recording medium readable by a computer, and including instructions of a computer program as mentioned above.

The information or recording medium can be any entity or device capable of storing the programs. For example, the media can include a storage means, such as a ROM, for example a CD ROM or a microelectronic circuit ROM, or a magnetic recording means, for example a floppy disk or a hard drive or a flash memory.

On the other hand, the information or recording medium can be a transmissible medium such as an electrical or optical signal, which can be routed via an electrical or optical cable, by radio link, by wireless optical link or by other means.

The program according to the invention can be particularly downloaded from an Internet type network.

Alternatively, the information or recording medium can be an integrated circuit in which a program is incorporated, the circuit being adapted to execute or to be used in the execution of any of the methods as described above.

It can also be envisaged, in other embodiments, that the management method, the orchestration method, the management device, the orchestration entity and the system according to the invention present in combination all or part of the aforementioned characteristics.

### BRIEF DESCRIPTION OF THE DRAWINGS

Other characteristics and advantages of the present invention will emerge from the description given below, with reference to the appended drawings which illustrate one exemplary embodiment devoid of any limitation. In the figures:

FIG. 1 already described represents a software network in accordance with the state of the art;

FIG. 2 represents a system in accordance with one particular embodiment of the invention;

FIG. 3 represents successive states of a network in a resilience space;

FIG. 4 illustrates the effect of an orchestration action;

FIG. 5 illustrates distances between states in a resilience space;

FIG. 6 illustrates the calculation of reputations in different situations;

FIG. 7 represents the main steps implemented by the modules, devices and entities of the system of FIG. 2 in one particular embodiment;

FIG. 8 represents the hardware architecture of a management device in accordance with one particular embodiment of the invention;

FIG. 9 represents the functional architecture of a management device in accordance with one particular embodiment of the invention;

FIG. 10 represents the hardware architecture of an orchestration entity in accordance with one particular embodiment of the invention; and

FIG. 11 represents the functional architecture of an orchestration entity in accordance with one particular embodiment of the invention.

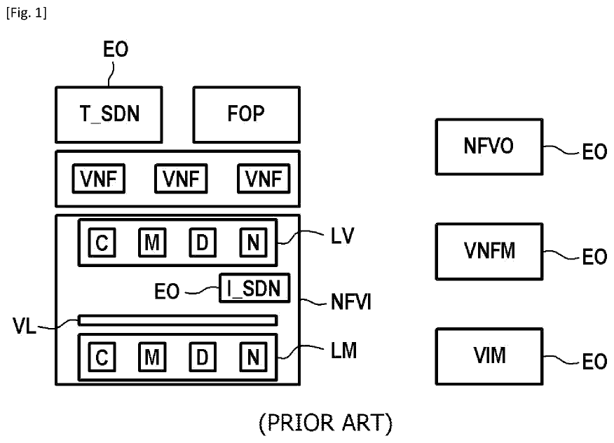

### DETAILED DESCRIPTION OF PARTICULAR EMBODIMENTS OF THE INVENTION

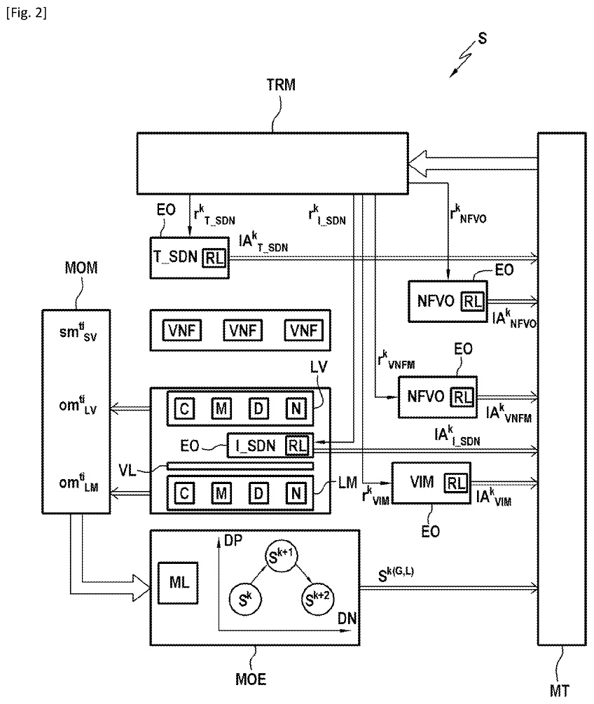

FIG. 2 represents a system S in accordance with one embodiment of the invention. This system is described in the context of the analysis of a virtualized network VR in which a service SV is implemented, this service SV relying on virtualized network functions VNF.

In the embodiment described here, the state S_{SV}^{ti} of this service SV, at a given instant ti, can be defined from a set (or conjunct) sm_{SV}^{ti} of nSV service metrics at this instant ti, nSV referring to an integer greater than or equal to 1. We note sm_{SV}^{ti}=[sm₁^{ti}, . . . , Sm_{nSV}^{ti}], the set of the nSV metrics describing the service SVn at instant ti. These service metrics comprise for example:
a latency metric sm₁^{ti};
a jitter metric sm₂^{ti};
a bandwidth metric sm₃^{ti}; . . . and
a number sm₃^{ti} of failed calls.

In one embodiment of the invention, a predetermined function f_{SV} is used to estimate a state S_{SV}^{ti} of the service SV at instant ti from the metrics smₛᵥ^{ti}. In other words, in this embodiment: S_{SV}^{ti}=f_{SV}(smₛᵥ^{ti})=fₛᵥ(sm₁^{ti}, . . . , sm_{nSV}^{ti}).

The states S_{SV}^{ti} of the service SV calculated at different instants ti allow to define a state S_{SV}^{k} of the service SV in a time window T^{k}. This state S_{SV}^{k} can here be qualified as stable. For example, S_{SV}^{k} is the average of the states S_{SV}^{ti} of the service SV calculated at different instants ti of the time window T^{k}. As a variant, statistical functions other than the average, for example regression functions, can be used to calculate a state S_{SV}^{k} of the service for the time window T^{k} from the instantaneous service states S_{SV}^{ti}.

In one embodiment, the implementation of the service SV involves two operational layers, namely:
an operational layer LV of virtual resources (virtual machines, containers, etc.); and
an operational layer LM of hardware and software resources (servers, etc.).

Each of these operational layers LV, LM is described by a set (or conjunct) of operational metrics. We note:
om_{LM}^{ti}=[om_{LM,1}^{ti}, . . . , om_{LM,nLM}^{ti}], the set of the nLM operational metrics describing the layer LM of the hardware and software resources at instant ti, nLM designating an integer greater than or equal to 1; and
om_{LV}^{ti}=[om_{LV,1}^{ti}, . . . , om_{LV,nLV}^{ti}], the set of the nLV operational metrics describing the layer LV of the virtual resources at instant ti, nLV referring to an integer greater than or equal to 1.

These instantaneous metrics are measured on the equipment of the physical virtualization infrastructure NFVI.

As an example, operational metrics om_{LM,i} used to describe the layer LM of the hardware and software resources at instant ti can comprise:
metrics relating to the occupancy or statuses of CPUS;
metrics relating to the occupancy or statuses of memories;
metrics relating to the occupancy or statuses of disks; and
metrics relating to the occupancy or statuses of network resources, of NFVI infrastructure equipment.

Likewise, still as an example, operational metrics om_{LV,i}^{ti} used to describe the layer LV of the virtual resources at instant ti can comprise:
metrics relating to the occupancy or statuses of virtualized CPU functions;
metrics relating to the occupancy or statuses of virtualized memory functions;
metrics relating to the occupancy or statuses of virtualized disk functions; and
metrics relating to the occupancy or statuses of virtualized network functions, of the containers or of the virtual machines executed by servers of the NFVI infrastructure.

In one embodiment of the invention, a predetermined function f_{LM} is used to estimate a state S_{LM}^{ti} of the operational layer LM of the hardware and software resources at instant ti from the metrics om_{LV}^{ti}. In other words, in this embodiment:

$${S}_{LM}^{ti} = {f}_{LM} ( {om}_{LV}^{ti} ) = {f}_{LM} ( {om}_{LM , 1}^{ti} , … , {om}_{LM , nLM}^{ti} )$$

The states S_{LM}^{ti} of the operational layer LM of the hardware and software resources calculated at different instants ti allow to define a state (qualified as stable) S_{LM}^{k} of this layer in a time window T^{k}. For example, S_{LM}^{k} is the average of the states S_{LM}^{ti} of the layer LM calculated at different instants ti of the time window T^{k}. As a variant, other statistical functions than the average, for example regression functions, can be used to calculate a state S_{LM}^{k} of the layer LM for the time window T^{k} from the instantaneous states S_{LM}^{ti}.

In one embodiment of the invention, a predetermined function f_{LV} is used to estimate a state S_{LV}^{ti} of the operational layer LV of the virtual resources at instant ti from the metrics om_{LV}^{ti}. In other words, in this embodiment:

$${S}_{LV}^{ti} = {f}_{LV} ( {om}_{LV}^{ti} ) = {f}_{LV} ( {om}_{LV , 1}^{ti} , … , {om}_{LV , nLV}^{ti} )$$

The states S_{LV}^{ti} of the operational layer LV of the virtual resources calculated at different instants ti allow to define a state (qualified as stable) S_{LV}^{k} of this layer in a time window T^{k}. For example, S_{LV}^{k} is the average of the states S_{LV}^{ti} of the layer LV calculated at different instants ti of the time window T^{k}. As a variant, other statistical functions than the average, for example regression functions, can be used to calculate a state S_{LV}^{k} of the layer LV for the time window T^{k} from the instantaneous states S_{LV}^{ti}.

In the remainder of the description, L will refers to an operational layer LM or LV and G refers to the metrics of a type of particular resources. For example G can take 4 values C, M, D and N to refer to metrics relating:
to hardware and software CPU resources of the layer LM or to virtualized CPU functions of the layer LV (G=C);
to hardware and software disk resources of the layer LM or to virtualized disk functions of the layer LV (G=D);
to hardware and software memory resources of the layer LM or to virtualized memory functions of the layer LV (G=M);
to hardware and software network resources of the layer LM or to virtualized network functions of the layer LV (G=N).

Concrete examples of CPU metrics (G=C) are for example:
node_cpu_core_throttles_total{core=“0”, package=“0”} (number of times the frequency of a CPU was limited to avoid or deal with overheating) or
node_cpu_scaling_frequency_hertz{cpu=“4”} (current value of the frequency of the fourth core of the CPU).

In one particular embodiment, the invention proposes to define eight states of the software network S^{k(G,L)} in the time window T^{k}, with:
G=C, D, M or N; and
L=LM or LV.

Thus and as an example, the notation S^{k(N, LV)} refers to a state of the software network defined by:
the state S_{LV}^{k} of the service SV in the time window T^{k}, and
a state S_{LV}^{k} of the operational layer of the virtual resources LV in the time window T^{k} calculated from the metrics relating to the virtualized network functions.

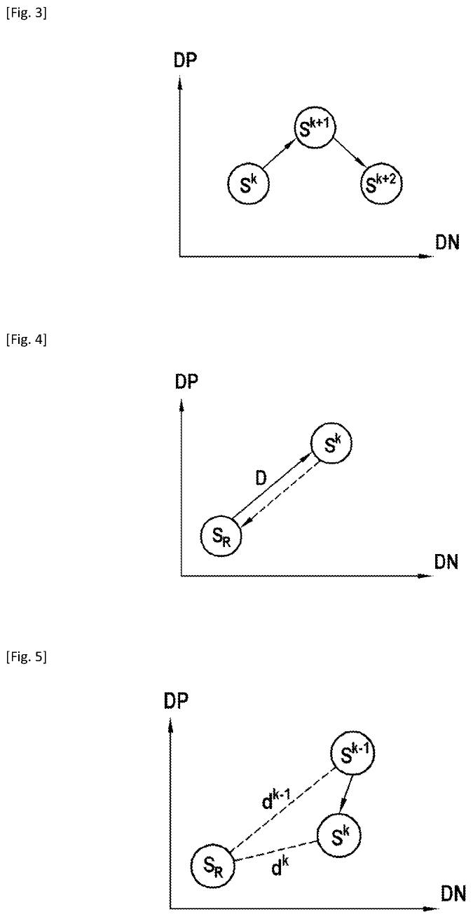

As represented in FIG. 3, the states S^{k}, S^{k+1}, S^{k+2} of the software network ((G,L) omitted for the sake of simplification) in successive time windows T^{k}, T^{k+1}, T^{k+2} can be represented in a two-dimensional space in which:
the dimension DP (ordinate axis) represents the state S_{LV}^{k} of the service SV; and
the dimension DN (abscissa axis) represents an operational state S_{L}^{k} of a hardware LM or virtual LV operational layer which provides this service in the network.

In this FIG. 3, the arrows represent transitions of the network between two states S^{k}, S^{k+1}, respectively between two states S^{k+1},S^{k+2}, of successive time windows T^{k}, T^{k+1}, respectively of successive time windows T^{k+1}, T^{k+2}.

Returning to FIG. 2, the system S includes a module MOM for obtaining metrics of the virtualized network. In the embodiment described here, this module MOM is configured to collect, at different instants ti:
the service metrics sm_{SV}^{ti};
the metrics om_{LM}^{ti} of the operational layer of the hardware resources LM; and
the metrics om_{LV}^{ti} of the operational layer of the virtual resources LV.

In the embodiment described here, the system S includes a module MOE for obtaining states S^{k} of the software network in different time windows T^{k} from the service metrics sm_{SV}^{ti} and the operational metrics om_{LV}^{ti} and om_{LM}^{ti} collected by the module MOM at different instants ti in these time windows T^{k}.

In one embodiment of the invention, the state obtaining module MOE uses predetermined functions f_{SV}, f_{LM}, f_{LV} to calculate the states S_{SV}^{k} of the service SV, the states S_{LV}^{k} of the operational layer of the virtual resources LV and the states S_{LM}^{k} of the operational layer of the hardware resources LM in the time window T^{k} from the different metrics.

These functions f_{SV}, f_{LM}, f_{LV} are for example classification functions able to perform a mapping of the metrics to a state. Thus for example, the function fₛᵥ can be a function able to map the metrics smₛᵥ^{ti} with a service state S_{SV}^{ti}. These functions can be implemented in the form of neural networks.

In another embodiment, the state obtaining module MOE uses a learning-based method (Machine Learning) ML which takes as input the metrics om_{LM}^{ti} and om_{LV}^{ti} of the operational layers LM and LV and the service metrics sm_{SV}^{ti} to compress these metrics and calculate the states S^{k} of the network at each time window T^{k}.

For example, this method can use an auto-encoder and use a reconstruction error to compress the metrics om_{LM}^{ti}, om_{LM}^{ti} and sm_{SV}^{ti} onto a single indicator S^{k}.

As a variant, this method can combine a technique for reducing the dimensionality, for example the PCA (Principal Component Analysis) method and a clustering technique to project the metrics onto a two-dimensional space, recognize the clusters of the metrics and define the states from these clusters.

In one particular embodiment, the state obtaining module MOE can calculate the successive states S^{k(G,L)} (and the transitions) for each operational layer L (LM or LV) and for each group G of metrics C, D, M and N (CPU, disk, memory and network).

In the embodiment described here, the state obtaining module MOE records the states S^{k} or S^{k(G,L)} in a buffer memory MT.

FIG. 4 illustrates, in general, an objective aimed by the orchestration entities EO (NFVO, VNFM, VIM, T-SDN, I-SDN).

This figure represents, in a resilience space of the type of that of FIG. 3, a state S_{R} of the network considered as a reference state and a degraded state S^{k} of this network. The gap between these states S_{R} and S^{k} can be qualified as deviation D; it is represented by a solid line arrow in FIG. 4.

A role of the orchestration entities EO is to set up one or several orchestration actions to compensate for such a state deviation D, so that the network returns or tends to return from its degraded state S^{k} to its state reference S_{R} as illustrated by the dotted line arrow in FIG. 4.

For example, an orchestration entity like the VIM, which manages virtual machines, could observe that the CPU level is insufficient (degraded state) and apply a vertical or horizontal scalability orchestration action.

In the embodiment described here, each orchestration entity EO records in the buffer memory MT an indication IA^{k} whether it has implemented one or several orchestration actions A^{k} during the time window T^{k}. In FIG. 2, we note:
IA^{k}_{T-SDN} an indication that one or several actions have been performed by the T-SDN controller;
IA^{k}_{T-SDN} an indication that one or several actions have been performed by the I-SDN controller;
IA^{k}_{NFVO} an indication that one or several actions have been performed by the NFVO orchestrator;
IA^{k}_{VNFM} an indication that one or several actions have been performed by the VNFM manager;
IA^{k}_{VIM} an indication that one or several actions have been performed by the VIM manager during the time window T^{k}.

In the embodiment described here, the system S includes a TRM management device configured to obtain from the buffer memory MT:
the states S^{k} or S^{k(G,L)} of the software network published by the module MOE for obtaining states of the network during a time window T^{k}; and
the indications IA^{k} that actions have been performed by the orchestration entities EO during this time window T^{k}.

In one particular embodiment of the invention, when the TRM management module receives the information that the software network is, in a time window T^{k}, in a degraded state S^{k} and that it recognizes that an orchestration entity EO has performed an action during this time window T^{k}, the TRM module sends to this orchestration entity EO a reputation value r_{EO}^{k} inversely proportional to the distance between the representation of the reference state S_{R} and the representation of the degraded state S^{k} in the resilience space of FIG. 4.

In one particular embodiment of the invention, the TRM module uses a reputation model such that the reputation value r_{EO}^{k} is difficult to be gained but easy to lose, to discourage the orchestration actions A^{k} of the orchestration entities EO which deviates the state of the system from the reference state S_{R} and which aggravate the failures by having a negative impact on the network. Thus, the reputation r_{EO}^{k} of an orchestration entity EO which deviates the current state from the reference state S_{R} must drop suddenly, decrease considerably or become relatively low. On the contrary, when an orchestration action A^{k} approaches the state S^{k} to the reference state S_{R} or maintains it around this reference state, the orchestration entity EO at the origin of this action A^{k} must be rewarded by the TRM management device by a slightly increasing, or relatively high, reputation value r_{EO}^{k}.

In another embodiment described with reference to FIG. 5, said reputation value r_{EO}^{k} is increased or decreased depending on whether said state S^{k} of the network approaches or deviates from said reference state S_{R} compared to a state S^{k-1} of the network in a time window T^{k-1} prior to said time window T^{k}.

For example, by noting;
d^{k} the distance between the reference state S_{R}; and
r_{EO}^{k} the reputation value calculated for the time window T^{k};
   r_{EO}^{k}=r_{EO}^{k-1}·d^{k-1}/d^{k} can be defined.

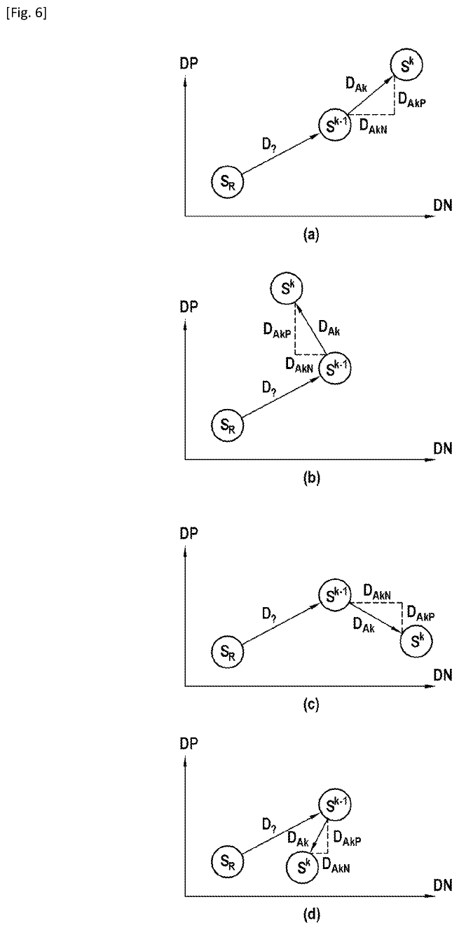

In another embodiment described with reference to FIGS. 6A to 6D, two types of transition between states of the software network are considered, namely:
transitions called “spontaneous” transitions (referenced D_{?}) when the network undergoes a degradation that cannot be assigned to an orchestration entity EO, for example due to a failure or misuse of equipment. The TRM module considers that a transition that occurs in a time window T^{k} is spontaneous if this TRM module does not receive any indication IA^{k} of an orchestration action A^{k} for this time window; and
transitions called “non-spontaneous” transitions (referenced D_{Ak}) in which the network switches from a state S^{k-1} to a new state S^{k} due to an orchestration action A^{k} performed by an orchestration entity EO, this action which can have a positive (S^{k} approaches the reference state S_{R} compared to S^{k-1}) or negative (S^{k} deviates from the reference state S_{R} compared to S^{k-1}) impact on the network.

In this embodiment and as represented in FIG. 6, we note:
D_{AkN} the component of D_{Ak} along the abscissa axis DN; and
D_{AkP} the component of D_{Ak} along the ordinate axis DP.

In the situation of FIG. 6A, the components D_{AkN} and D_{AkP} are positive. In the embodiment described here, the TRM module sends to the orchestration entity EO having performed the action A^{k} a negative reputation value r_{EO}^{k} proportional to D_{AkP} and inversely proportional to D_{?}, D_{?} also referring to the distance between S_{R} and S^{k-1}.

In the situation of FIG. 6B, the component D_{AkN} is negative and the component D_{AkP} is positive. In the embodiment described here, the TRM module sends to the orchestration entity EO having performed the action A^{k} a negative reputation value r_{EO}^{k} proportional to D_{AkP}/D_{?}.

In the situation of FIG. 6C, the component D_{AkN} is positive and the component D_{AkP} is negative. In the embodiment described here, the TRM module sends to the orchestration entity EO having performed the action A^{k} a negative reputation value r_{EO}^{k} proportional to D_{AkN}/D_{?}.

In the situation of FIG. 6D, the components D_{AkN} and D_{AkP} are negative. In the embodiment described here, the TRM module sends to the orchestration entity EO having performed the action A^{k} a positive reputation value r_{EO}^{k} proportional to D_{AkP} and inversely proportional to D_{?}.

As represented in FIG. 2, in the embodiment described here, the orchestration entities EO receive the reputation values r_{EO}^{k} from the TRM module. We note for example r_{VIM}^{k} the reputation value that the TRM module sends to the VIM manager.

In the embodiment described here, at the start of the setup of the service SV, each orchestration entity EO has a zero reputation value r_{EO}. Then, as an orchestration entity EO performs orchestration actions A^{k}, this entity EO receives from the TRM module reputation values r_{EO}^{k} which allow this orchestration entity EO to understand whether the orchestration actions A^{k} performed with the aim of correcting a degraded state of the network are effectively effective in bringing the network back into or towards its reference state S_{R}.

In other words, these reputation values r_{EO}^{k} serve as feedback to the orchestration entities on the impact of their orchestration actions.

In the embodiment described here, the orchestration entities EO use the reputation values r_{EO}^{k} to optimize and/or correct their future orchestration actions in order to better react to future degradations.

Thus, in the embodiment described here, each orchestration entity EO includes an RL agent configured to implement a reinforcement learning (or RL) method. This RL agent receives as input the reputation values r_{EO}^{k} and selects as output the orchestration actions adapted to react to a given degradation.

The principle of such a reinforcement learning method is known to those skilled in the art. In this case, it could implement a reinforcement learning algorithm to achieve a transition from the current state to a target state based on a feedback signal generated following an orchestration action.

In the embodiment described here, taking into account these reputation values rEOk allows:
the orchestrator NFVO to improve its management of the life cycle of the network services
the manager VNFM to improve the VNFs life cycle support;
the manager VIM to improve the placement of the virtual machines and the management of their life cycles;
the controllers T-SDN and I-SDN to improve the traffic routing path, each at their own level. The I-SDN manages the connections between the VNFs and the T-SDN can control the traffic at the tenant level being seen as another network function (VNF). On this point, those skilled in the art can refer to document “Network Slicing for 5G with SDN/NFV: Concepts, Architectures and Challenges, Ordonez et al, March 2017, IEEE Communications Magazine 55(5)”.

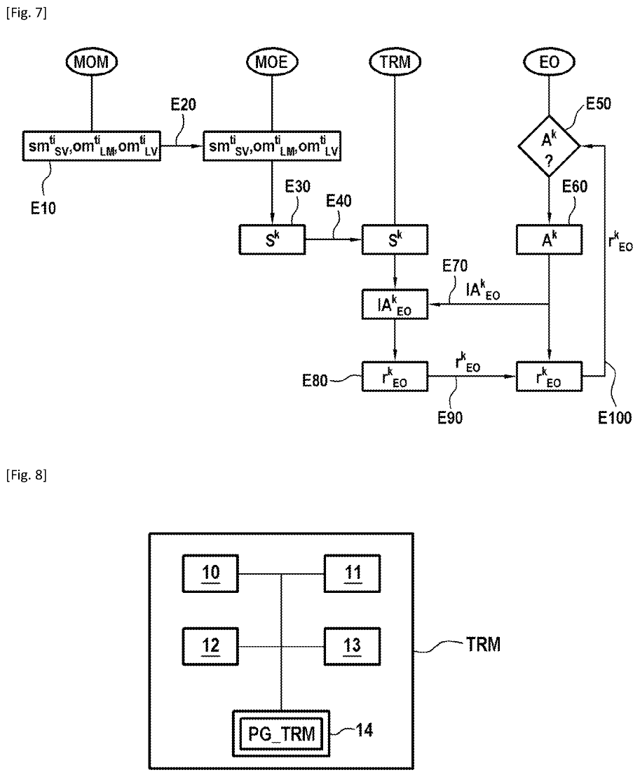

FIG. 7 represents the main steps implemented by the modules, devices and entities of the system of FIG. 2 in one particular embodiment. The steps implemented by the TRM management device constitute an example of a management method in accordance with the invention. Likewise, the steps implemented by the orchestration entity EO constitute an example of an orchestration method in accordance with the invention.

During a step E10, the obtaining module MOM obtains at different instants ti:
the service metrics sm_{SV}^{ti};
the metrics om_{LM}^{ti} of the operational layer of the hardware resources LM; and
the metrics om_{LV}^{ti} of the operational layer of the virtual resources LV.

The module MOM communicates these metrics to the state obtaining module MOE during a step E20.

During a step E30, the state obtaining module MOE calculates the states S^{k} of the network for different time windows T^{k}. For example, it uses a learning-based method which takes as input the metrics om_{LM}^{ti} and om_{LV}^{ti} of the operational layers LM and LV and the service metrics sm_{SV}^{ti}.

The module MOE communicates the states S^{k} of the network to the TRM management device during a step E40.

During a general step E50, an orchestration entity EO decides on the orchestration actions to be performed in the software network. It performs the action A^{k} during a step E60. During a step E70, it sends to the TRM management device an indication IA_{EO}^{k} that it has performed at least one orchestration action during the time window T^{k}.

During a step E80, the TRM management device calculates a reputation value r_{EO}^{k} for the time window T^{k} and the orchestration entity EO. This reputation value r_{EO}^{k} represents the fact that the state S^{k} of the network has been improved or degraded by the action A^{k} performed by the orchestration entity EO.

The TRM management device sends the reputation value r_{EO}^{k} to the orchestration entity EO during a step E90.

During a step E100, the orchestration entity EO injects this reputation value r_{EO}^{k} into its learning system RL. It will be taken into account during a subsequent iteration of step E50 to select a future orchestration action.

FIG. 8 represents the hardware architecture of a TRM management device in accordance with one particular embodiment of the invention. In the embodiment described here, this device has the hardware architecture of a computer. It includes a processor 10, communication means 11 on a network, a RAM type random access memory 12, a rewritable non-volatile memory 13 and a read-only memory 14. The read-only memory constitutes an information medium for storing a computer program PG-TRM in accordance with the invention. When the processor 10 executes this computer program, it implements the management method described with reference to FIG. 7.

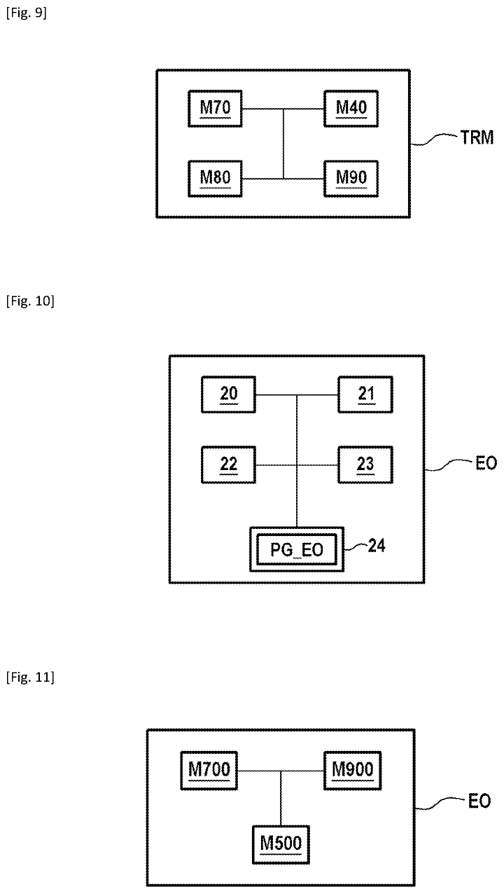

FIG. 9 represents the functional architecture of a TRM management device in accordance with one particular embodiment of the invention. This device can be implemented in hardware as illustrated in FIG. 8. It includes:
a module M70 for obtaining an indication IA^{k} that an orchestration entity EO has performed at least one orchestration action A^{k} in the network during a time window (T^{k});
a module M40 for obtaining at least one state S^{k} of the network in said time window T^{k}, said state S^{k} of the network including a state S_{SV}^{k} of a service implemented in the network and a state S_{L}^{K} of at least one operational layer of the network for the implementation of this service SV;
a module M80 for obtaining, from said state of the network S^{k} and a reference state S_{R} of said network, a reputation value r_{EO}^{k} representative of an improvement or deterioration in the state of the network; and
a module M90 for sending the reputation value r_{EO}^{k} to the orchestration entity (EO).

FIG. 10 represents the hardware architecture of an orchestration entity EO in accordance with one particular embodiment of the invention. In the embodiment described here, this entity EO has the hardware architecture of a computer. It includes a processor 20, communication means 21 on a network, a RAM type random access memory 22, a rewritable non-volatile memory 23 and a read-only memory 24. The read-only memory constitutes an information medium for storing a computer program PG-EO in accordance with the invention. When the processor 20 executes this computer program, it implements the orchestration method described with reference to FIG. 7.

FIG. 11 represents the functional architecture of an orchestration entity EO in accordance with one particular embodiment of the invention. This entity can be implemented in hardware as illustrated in FIG. 10. It includes:
a module M700 for sending, to a TRM management device, an indication IA^{k} that said orchestration entity EO has performed at least one orchestration action A^{k} in said network during a time window T^{k};
a module M900 for receiving a reputation value r_{EO}^{k} coming from said TRM management device;
a module M500 for selecting an orchestration action, this module being configured to take into account said reputation value r_{EO}^{k} to select an orchestration action to be performed in the network.

1. A method for managing at least one orchestration entity in a software network, the method being implemented by a device for managing said at least one orchestration entity, the method comprising:
obtaining, from said orchestration entity, an indication that said orchestration entity has performed at least one orchestration action (A^{k}) in said network during a time window;
obtaining at least one state of the network in said time window, said state of the network including a state of a service implemented in the network and a state of at least one operational layer of the network for implementation of said service;
obtaining, from said state of the network and a reference state of said network, a reputation value representative of an improvement or degradation of a state of the network; and
sending said reputation value to said orchestration entity.

2. The method of claim 1, wherein said at least one operational layer is a layer of hardware and software resources or a layer of virtual resources of said network, said state of said at least one operational layer being obtained from metrics describing said layer at different said time window.

3. The method according to of claim 2, wherein said operational layer is described from metrics of a single group of resources chosen from CPU type metrics, memory type metrics, disk type metrics or network-type metrics.

4. The method of claim 1, wherein said state of said service is obtained from metrics describing said service at different time instants within said time window.

5. The method of claim 2, wherein said state of the network is computed by a learning-based system taking as input said metrics.

6. The method of claim 1, wherein said reputation value is increased or decreased depending on whether said state of the network approaches or deviates from said reference state relative to a state of the network in a time window prior to said time window.

7. The method of claim 6, wherein to calculate a distance between two states of the network, the two states are represented in a two-dimensional space in which a first dimension represents said state of the service and a second dimension represents said state of said at least one operational layer.

8. A device for managing at least one orchestration entity in a software network, the device comprising:
a module for obtaining an indication that said orchestration entity has performed at least one orchestration action in said network during a time window;
a module for obtaining at least one state of the network in said time window, said state of the network including a state of a service implemented in the network and a state of at least one operational layer of the network for implementation of said service;
a module for obtaining, from said state of the network and a reference state of said network, a reputation value representative of an improvement or degradation of a state of the network; and
a module for sending said reputation value to said orchestration entity.

9. An orchestration method implemented by an orchestration entity in a software network, the method including:
sending, to a management device, an indication that said orchestration entity has performed at least one orchestration action in said network during a time window;
receiving a reputation value obtained by said management device by implementing the method of claim 1; and
taking into account said reputation value to select an orchestration action to be performed in said network.

10. An orchestration entity comprising:
a module for sending, to the management device of claim 8, an indication that said orchestration entity has performed at least one orchestration action in said network during a time window;
a module for receiving a reputation value coming from said management device; and
a module for selecting an orchestration action, said module for selecting an orchestration action being configured to take into account said reputation value to select an orchestration action to be performed in said network.

11. A system comprising:
the management device of claim 8; and
at least one orchestration entity comprising:
a module for sending, to the management device of claim 8, an indication that said orchestration entity has performed at least one orchestration action in said network during a time window;
a module for receiving a reputation value coming from said management device; and
a module for selecting an orchestration action, said module for selecting an orchestration action being configured to take into account said reputation value to select an orchestration action to be performed in said network.

12. A non-transitory computer readable medium having stored thereon instructions which, when executed by a processor, cause the processor to implement the method of claim 1.

13. A non-transitory computer readable medium having stored thereon instructions which, when executed by a processor, cause the processor to implement the method of claim 9.

14. (canceled)
